(19) United States
(12) Patent Application Publication
(10) Pub. No.: US 2018/0325763 A1
(43) Pub. Date: Nov. 15, 2018

(54) DECOMPRESSION DEVICE

(71) Applicant: Thomas A. Bilek, Vancouver, WA (US)

(72) Inventor: Thomas A. Bilek, Vancouver, WA (US)

(21) Appl. No.: 15/970,320

(22) Filed: May 3, 2018

Related U.S. Application Data
(60) Provisional application No. 62/503,618, filed on May 9, 2017.
(60) Provisional application No. 62/522,965, filed on Jun. 21, 2017.

(51) Int. Cl. A61H 1/02

(52) U.S. Cl. CPC A61H 1/0229; A61H 2201/5053; A61H 2203/0437; A61H 2201/165; A61H 2201/1626; A61H 2201/1418; A61H 2203/0487

(57) ABSTRACT

A decompression device may include a support structure to which a harness and a base may be coupled. A positional motivator may also be coupled to the support structure. The positional motivator may be configured to both change and maintain the distance between the base and portions of the harness. The base may be positioned on a surface or structure, and portions of the harness may be positioned around the body of a user, such as under the arms and around the back. The user may manipulate the positional motivator to position portions of the harness a desired distance from the base. Optionally, the user may then lean forwards with the support structure and the harness will provide additional lift, and therefore decompression, to the body and back of the user.

### CROSS REFERENCE TO RELATED APPLICATIONS

This application claims priority to and the benefit of the filing date of U.S. Provisional Application Nos. 62/503,618 and 62/522,965, filed on May 9, 2017 and Jun. 21, 2017 respectively which are hereby incorporated by reference in their entirety.

### FIELD OF THE INVENTION

This patent specification relates to the field of therapeutic orthopedic devices. More specifically, this patent specification relates to devices configured to provide decompression to a body.

### BACKGROUND

Many individuals suffer from chronic back pain. While surgery, drug therapy, and chiropractic manipulation are employed for the treatment of back pain, the use of traction or decompression therapy is preferable to many individuals. Decompression therapy is effective for treating many types of pain including low back, neck, and radiating leg and arm pain. Spinal or back decompression therapy decompresses spinal discs and facet joints by utilizing traction, distraction, and body positioning.

Some devices for providing decompression therapy require permanent installation in a building or a large, sturdy framework. However, these devices are typically costly, not portable, and/or not suitable for home use. Other decompression therapy devices rely on being attached to a structure that is capable of supporting all or a percentage of the weight of a user. Unfortunately, users may not be readily able to attach the devices to such structures due to their back pain. Other users may incorrectly attach the devices resulting in the risk of falling and further injury. Still other decompression therapy devices rely on the user being immobile for periods of time which can be uncomfortable and undesirable for many people.

Therefore, a need exists for novel devices configured to provide decompression to a body. There is also a need for novel decompression therapy devices which do not require permanent installation in a building or a large, sturdy framework. A further need exists, for novel decompression therapy devices which do not require the user to attach the device to a structure that is capable of supporting all or a percentage of the weight. Finally, a need exists for novel decompression therapy devices that do not require the user to be immobile for periods of time.

### BRIEF SUMMARY OF THE INVENTION

A decompression device is provided which is configured to provide decompression to the body of a user. In some embodiments, the device may include a support structure to which a harness and a base may be coupled. The harness may comprise a traction surface which may be positioned around portions of the body of a user. A positional motivator may also be coupled to the support structure. The positional motivator may be configured to control the distance between the base and the traction surface of the harness. The base may be positioned on a surface or structure, and the traction surface may be positioned around the body of a user, such as under the arms and around the back. The user may manipulate the positional motivator to position the traction surface a desired distance from the base and may position the base on a support object. The user may then lean portions of their body with the support structure and the harness so that the base may brace against a support object causing the traction surface to provide lift to portions of the body contacted by the traction surface resulting in decompression forces being applied to the body of the user.

In further embodiments, the device may comprise a positional motivator which may be configured to govern the distance that the traction surface may be positioned from the support structure. The device may include a support structure having a first cross brace. A harness having a traction surface may be movably coupled to the first cross brace. A positional motivator may couple the harness to the support structure, optionally via an extension. The positional motivator may be configured to control the distance between the traction surface and the first cross brace.

In still further embodiments, the device may include a positional motivator which may be configured to govern the distance that the base may be positioned from the support structure. The device may include a support structure having a first cross brace. A harness having a traction surface may be coupled to the first cross brace. A base may be movably coupled to the support structure via a positional motivator, and the positional motivator may be configured to control the distance between the base and the first cross brace. By controlling the distance between the base and the first cross brace, the positional motivator may also control the distance between the base and the traction surface.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of a decompression device according to various embodiments described herein.

FIG. 2 illustrates a rear perspective view of an example of a decompression device according to various embodiments described herein.

FIG. 3 shows a front perspective view of another example of a decompression device according to various embodiments described herein.

FIG. 4 depicts a rear perspective view of another example of a decompression device according to various embodiments described herein.

FIG. 5 illustrates a front perspective view of a further example of a decompression device according to various embodiments described herein.

FIG. 6 shows a rear perspective view of still another example of a decompression device in use according to various embodiments described herein.

FIG. 7 depicts a front perspective view of yet another example of a decompression device being used by a user according to various embodiments described herein.

FIG. 8 illustrates a rear perspective view of yet a further example of a decompression device according to various embodiments described herein.

FIG. 9 shows a front perspective view of yet a further example of a decompression device according to various embodiments described herein.

FIG. 10 depicts a front perspective view of still a further example of a decompression device according to various embodiments described herein.

FIG. 11 illustrates a rear perspective view of still a further example of a decompression device according to various embodiments described herein.

FIG. 12 shows a front perspective view of still yet a further example of a decompression device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

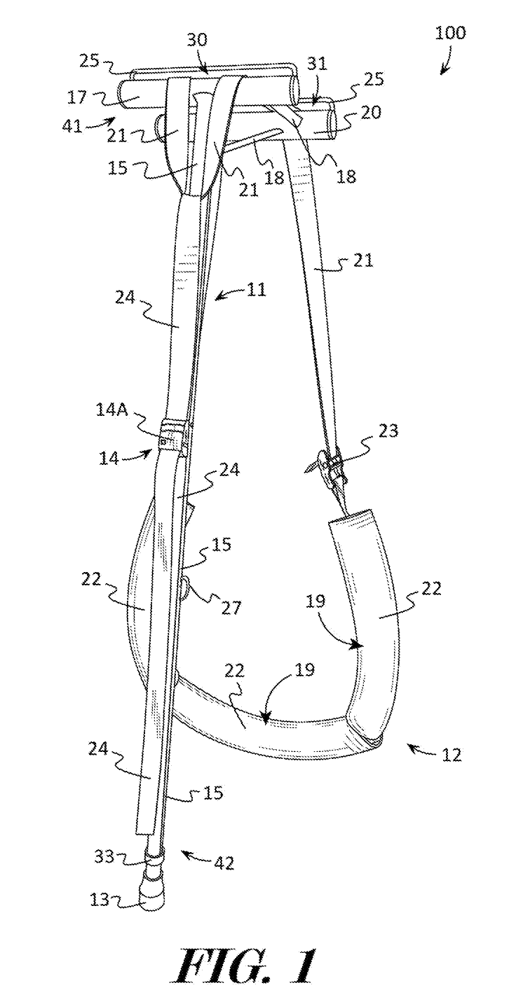

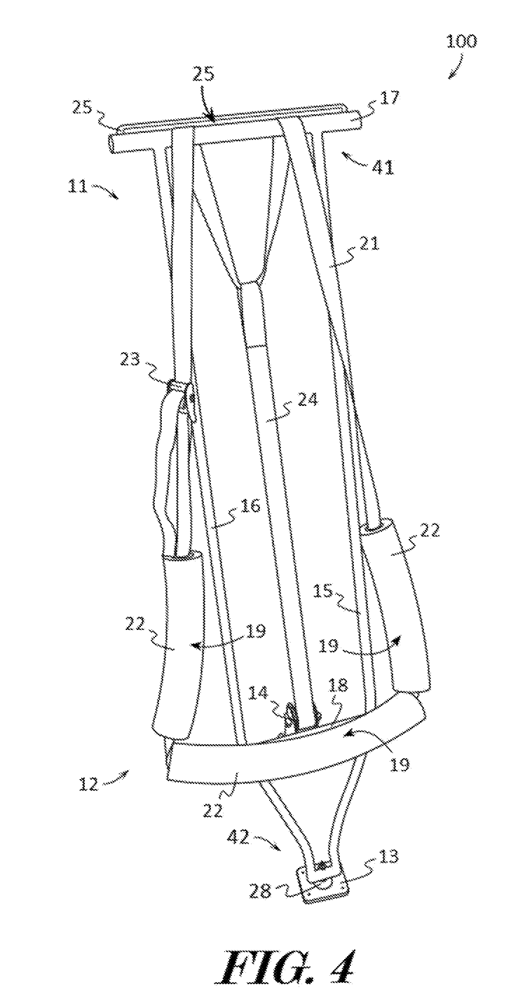

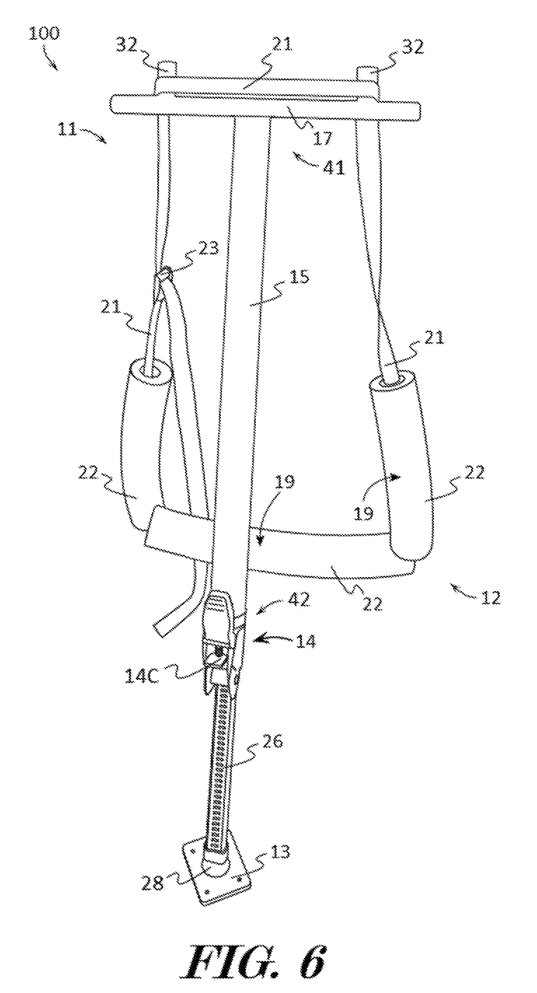

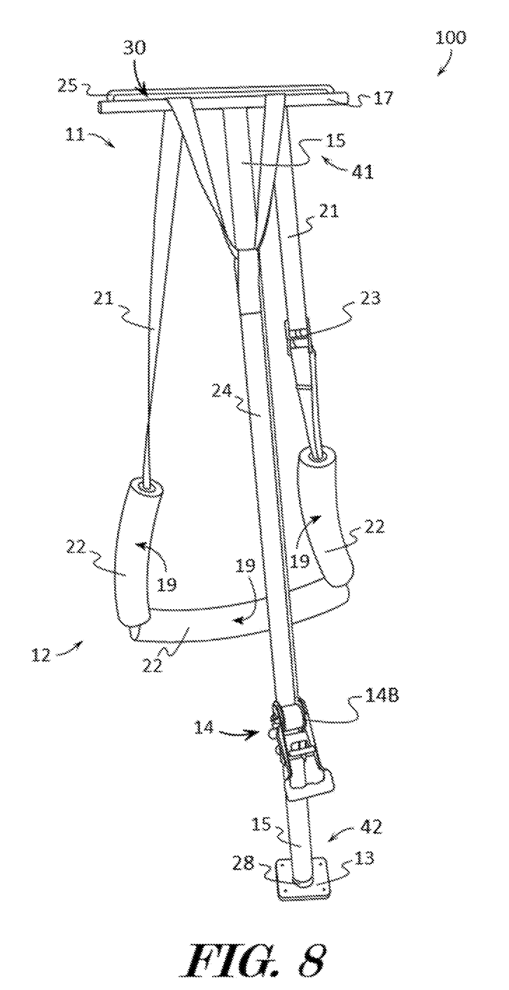

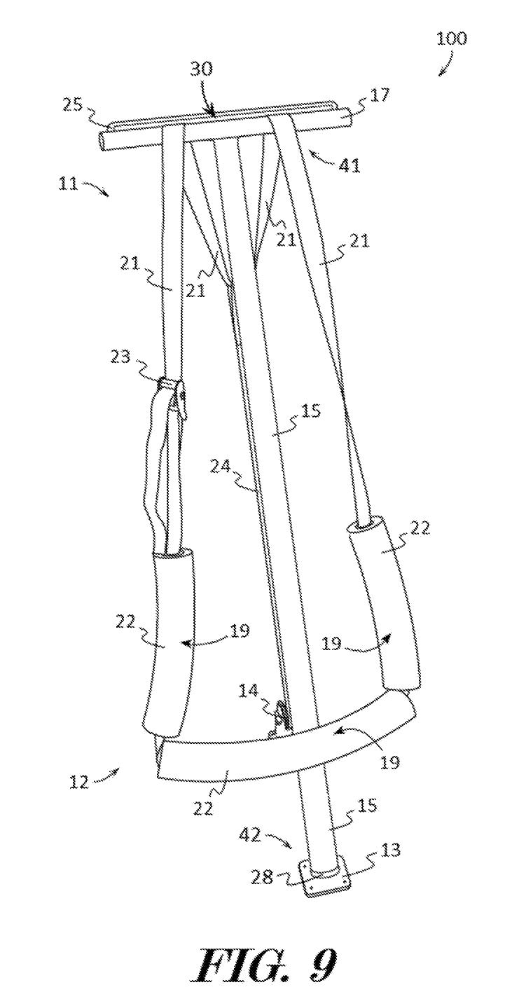

For purposes of description herein, the terms “upper”, “lower”, “left”, “center”, “right”, “rear”, “front”, “side”, “vertical”, “horizontal”, and derivatives thereof shall relate to the invention as oriented in FIGS. 1-9. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new device configured to provide decompression to a body is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIGS. 1 through 11 illustrate examples of a decompression device (“the device”) 100 according to various embodiments. In some embodiments, the device 100 may comprise a support structure 11 to which a harness 12 and a base 13 may be coupled. The harness 12 may comprise a traction surface 19 which may be positioned around portions of the body of a user 200. A positional motivator 14 may also be coupled to the support structure 11. The positional motivator 14 may be configured to control the distance between the base 13 and the traction surface 19 of the harness 12. The base 13 may be positioned on a surface or structure, and the traction surface 19 may be positioned around the body of a user 200, such as under the arms and around the back. The user 200 may manipulate the positional motivator 14 to position the traction surface 19 a desired distance from the base 13 and may position the base 13 on a support object 300. The user 200 may then lean portions of their body with the support structure 11 and the harness 12 so that the traction surface 19 may provide lift to portions of the body contacted by the traction surface 19 resulting in decompression forces being applied to the body of the user 200.

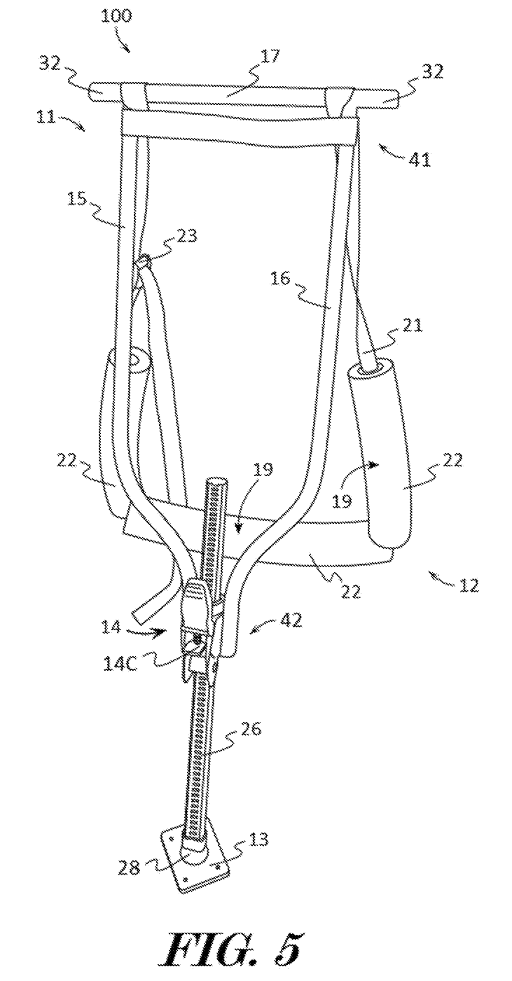

The support structure 11 may form a framework upon which the elements of the device 100 may be positioned and also which may transfer all or portions of the weight of a user 200 to the base 13. In some embodiments, the harness 12 may be coupled to the support structure 11 by coupling the harness 12 to a positional motivator 14 that is coupled to the support structure 11 as shown in FIGS. 1-4, 8, and 9-12. In other embodiments, the harness 12 may be coupled directly to the support structure 11 as shown in FIGS. 5-7.

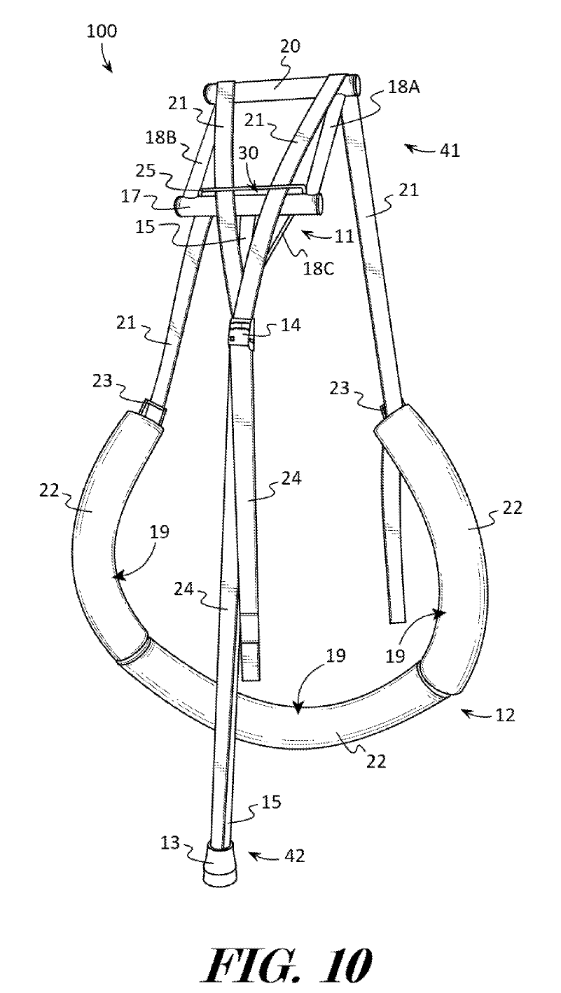

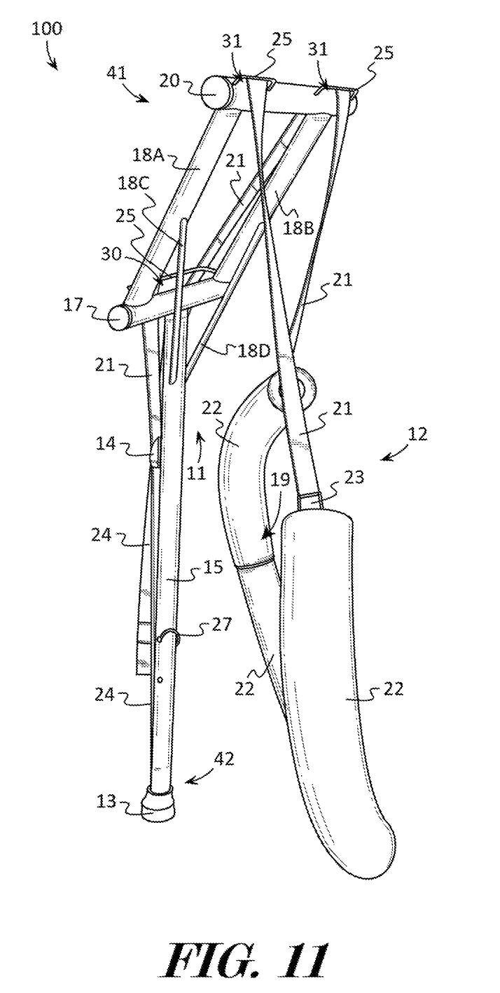

The support structure 11 may comprise an upper end 41 and an opposing lower end 42. Preferably, a harness 12 may be coupled to the upper end 41 while a positional motivator 14 and/or a base 13 may be coupled to or proximate to the lower end 42. A positional motivator 14 may be coupled anywhere on the device 100 and preferably to the support structure 11 directly or indirectly, such as via an extension 24. An extension 24 may comprise a length of nylon webbing, rope, chain, cable, or any other preferably flexible material or structure. In some embodiments, the support structure 11 may comprise one or more braces, such as a first longitudinal brace 15, a second longitudinal brace 16, a first cross brace 17, a second cross brace 20, a lateral brace(s) 18, and/or any number of other braces, which may be assembled and coupled together to form the support structure 11. A lateral brace(s) 18 may be used to couple and or support one or more other braces 15, 16, 17, 18, 20, together. For example, a lateral brace 18 may be configured as a first major lateral brace 18A (FIGS. 10 and 11) or a second major lateral brace 18B (FIGS. 10 and 11) which may be configured to couple a first cross brace 17 and a second cross brace 20 together. As another example, a lateral brace 18 may be configured as a first minor lateral brace 18C (FIGS. 10 and 11) or a second minor lateral brace 18D (FIG. 11) which may be configured to couple and support first major lateral brace 18A or a second major lateral brace 18B to the first longitudinal brace 15 and thereby supporting cross brace 20.

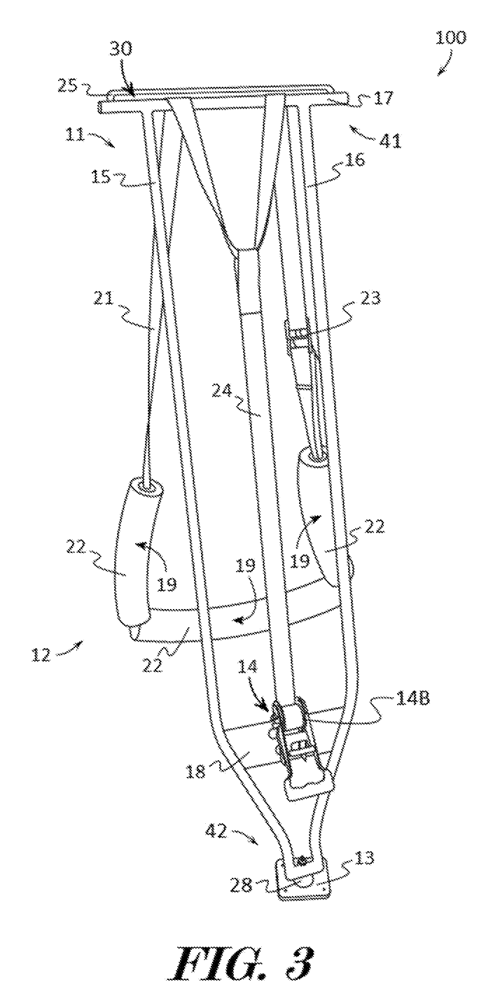

The device 100 may comprise one or more cross braces 17, 20. Generally, a cross brace 17, 20, may be disposed at the upper end 41 of the support structure 11 and may function as a fulcrum and/or an attachment point for the harness 12. In some embodiments, the device 100 may comprise a first cross brace 17 and a second cross brace 20 which may be coupled to the upper end 41 of the support structure 11 as shown in FIGS. 1, 2, 10, and 11. Preferably, the first cross brace 17 and second cross brace 20 may be oriented generally parallel to each other and may be separated by one or more lateral braces 18 a distance of between approximately 1.0 and 8.0 inches, and more preferably between 3.0 and 4.5 inches when cross braces 17, 20, are horizontal to each other. In other embodiments, a second cross brace 20 may be coupled above a first cross brace 17, such as at an approximately 45 degree angle as shown in FIGS. 10 and 11, thereby increasing the length of lateral brace 18. In other embodiments, the device 100 may comprise a single or first cross brace 17 which may be coupled to the upper end 41 of the support structure 11 as shown in FIGS. 3-9 and 12.

The device 100 may comprise one or more longitudinal braces 15, 16. Generally, a longitudinal brace 15, 16, may be used to couple elements at the upper end 41 of the support structure 11, such as brace(s) 17, 18, 20, to elements at the lower end 42 of the support structure 11, such as a positional motivator 14, beam 26, and/or base 13. In some embodiments, the device 100 may comprise a first longitudinal brace 15 and a second longitudinal brace 16 which may be coupled to the upper end 41 of the support structure 11 as shown in FIGS. 3-5, 7, and 12. In further embodiments, the device 100 may comprise a first longitudinal brace 15 as shown in FIGS. 1, 2, 8, and 9-11 or when combined with longitudinal brace 16 FIGS. 3, 4, and 12. In still further embodiments, a first longitudinal brace 15 may couple a first cross brace 17 to the base 13 as shown in FIGS. 1-4, 8, and 9-11. In still further embodiments, a first longitudinal brace 15 may couple a first cross brace 17 to a positional motivator 14 as shown in FIGS. 3-7. Optionally, a longitudinal brace 15, 16, (or any other brace(s) 17, 18, 20,) may be configured to be adjustable in length and/or may comprise one or more removable sections by having a brace coupling 27. A brace coupling 27 may comprise any type of removable fastener, such as a pin with pull ring as shown in FIGS. 1, 2, 10, and 11, a bolt or other threaded fastener, a ball and detent mechanism, and a turn-to-lock connection method.

It should be understood that the support structure 11 may be configured with any number of braces 15, 16, 17, 18, 20. For example, a support structure 11 may comprise a first longitudinal brace 15 combined with a second longitudinal brace 16 as shown in FIGS. 3-5, and 7, or as another example, the support structure 11 may comprise a first longitudinal brace 15 alone as shown in FIGS. 1, 2, 6, 8, and 9-11 which may be coupled together, when needed, with a first cross brace 17, a lateral brace 18, and/or any number of other braces. Braces 15, 16, 17, 18, 20, may be configured in any shape and size thereby forming a support structure in any shape and size. For example, the device 100 may comprise an elongated first longitudinal brace 15 and an elongated second longitudinal brace 16 which may be generally oriented parallel to each other and which may be coupled together with a first cross brace 17 and a lateral brace 18 which may be opposingly positioned on the ends of the longitudinal braces 15, 16. In another example, an upper or first cross brace 17 may be configured with a curved shape, such as by being curved in a concaved manner away from the user 200.

In some embodiments, a harness 12 may be movably coupled or otherwise maintained in contact with the support structure 11 with one or more strap apertures 30, 31. Generally, a strap aperture 30, 31, may form an opening, channel, or the like, through which portions of the harness 12 maybe positioned through and which may enable the portions of the harness 12 to freely move in and out or through the strap apertures 30, 31. In some embodiments, a strap aperture 30, 31, may be formed between a strap guide(s) 25 and a cross brace 17, 20, which may be coupled together. In further embodiments, the device 100 may comprise a first strap aperture 30, and portions of the harness 12 may be movably coupled within the first strap aperture 30 to a first cross brace 17 as shown in FIGS. 1-4, 8, and 9-11. In still further embodiments, the device 100 may comprise a second cross brace 20 and a second strap aperture 31, and portions of the harness 12 may be movably coupled within the second strap aperture 31 to the second cross brace 20. In other embodiments, a strap aperture 30, 31, and/or a strap guide 25 may comprise a hook, eyelet, pulley, or any other structure which may guide, limit, or restrain the movement of the harness 12 to or along the support structure 11. In further embodiments, the device 100 may comprise one or more anchor braces 32 which may be used to couple or to maintain the position of the harness 12 on a cross brace 17. Optionally, an anchor brace 32 maybe coupled to a cross brace 17 and which may extend away from the cross brace 17.

The support structure 11 may be made from or comprise steel alloys, aluminum, aluminum alloys, copper alloys, any other type of metal or metal alloy, any type of ceramic, earthenware, synthetic stone, various types of hard plastics, such as polyethylene (PE), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, wood, other plant based materials, or any other material including combinations of materials that are substantially rigid and suitable for supporting all or portions of the weight of a user. For example, the support structure 11 and/or braces 15, 16, 17, 18, 20, may comprise steel or aluminum tubing, plates, or bar stock. Optionally, the support structure 11 may be adjustable in size or shape, such as by one or more braces 15, 16, 17, 18, 20, which may be telescoping in structure or coupled together in a telescoping manner.

The device 100 may comprise one or more bases 13 which may be coupled directly or indirectly to the support structure 11. In further embodiments, a base 13 may be coupled to the support structure 11 by coupling the base 13 to a positional motivator 14 which is coupled to the support structure 11 as shown in FIGS. 5-7. In alternative embodiments, a base 13 may be coupled directly to the support structure 11 as shown in FIGS. 1-4 and 8-12.

In preferred embodiments, a base 13 may be movably coupled to the support structure 11 via an articulation joint 28 so that the base 13 may pivot, rotate, or otherwise be moved relative to the support structure 11. For example, the base 13 may be coupled to the support structure 11 with an articulation joint 28 which may comprise a ball joint, hinge, or other movable and/or flexible coupling. In further embodiments, an extension 24 may be coupled with or to the base 13 as shown in FIGS. 10 and 11.

A base 13 may be configured in any shape and size, such as a relatively small, rectangular shape, or a relatively larger oblong shape which may enable a user 200 to position portions of the base 13 under portions of their body. A base 13 may preferably comprise any durable and rigid material. Optionally, a base 13 may comprise a traction enhancing, cushioning, and/or non-marring material, such as silicone, polyacrylate rubber, and other rubbers and plastics.

A harness 12 may comprise any apparatus or device which may be used to contact and support portions of the body of a user 200, such as around the back and under the arms. In its simplest form, a harness 12 can be made from a length of flexible material, such as rope, nylon webbing, leather strap, or the like, which may be positioned around the body of a user 200. In further embodiments, a harness 12 may be made from or may comprise a flexible material such as polypropylene webbing, polyester webbing, various types of flexible plastics such as polyvinyl chloride, natural rubber, neoprene foam rubber, synthetic rubber material such as latex rubber, forms of the organic compound isoprene, Polyacrylate Rubber, Ethylene-acrylate Rubber, Polyester Urethane, a flexible plastic such as high-density polyethylene (HDPE), polyvinyl chloride (PVC), polypropylene (PP), Polystyrene (PS), Polycarbonate (PC), low density polyethylene (LDPE), synthetic fabrics such as polyester, nylon, rayon, acetate, spandex, spandex blends, and Kevlar, and natural fabrics such as coir, cotton, hemp, jute, canvas, flax, leather, linen, ramie, wool, silk, or any other flexible material.

In preferred embodiments, a harness 12 may comprise one or more traction surfaces 19 which may form the portion of the harness 12 for contacting the user 200 and which may form the portion of the harness 12 which may be positioned a desired distance from the base 13 via a positional motivator 14. Optionally, a traction surface 19 may be formed by the harness loop 21 and/or by a cushion 22. Preferably, a harness 12 may comprise a harness loop 21 which may be coupled directly to the support structure 11 or indirectly coupled to the support structure 11. Optionally, the length of portions of the harness 12, such as the harness loop 21, may be adjustable in length. In preferred embodiments, the harness 12 may comprise one or more adjustable fasteners 23, such as buckles, claps, clips, snap fasteners, cam buckles, ratcheting buckles, hook-and-loop type fasteners, or any other fastener, which may be used to adjustably and/or removably couple one or more portions of the harness 12 together so that portions of the harness 12 may be adjustable in length. In further embodiments, an adjustable fastener 23 may comprise one or more side release buckles, buckles, clasps, slides, loops, reducers, cam buckles, strap adjusters, snap hooks, D rings, tri-loops, footman loops, keepers, cord locks, strap locks, or any other suitable means for adjusting the length of portions of the harness 12.

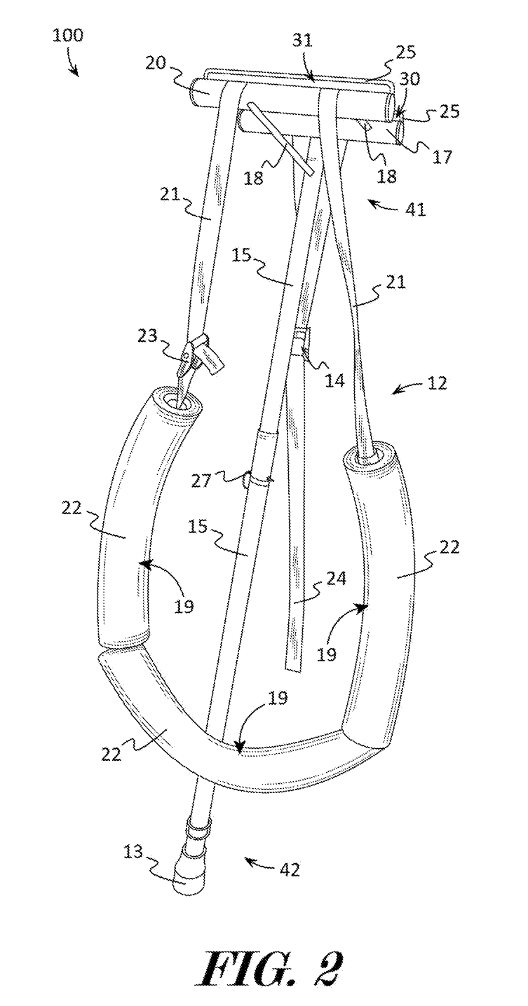

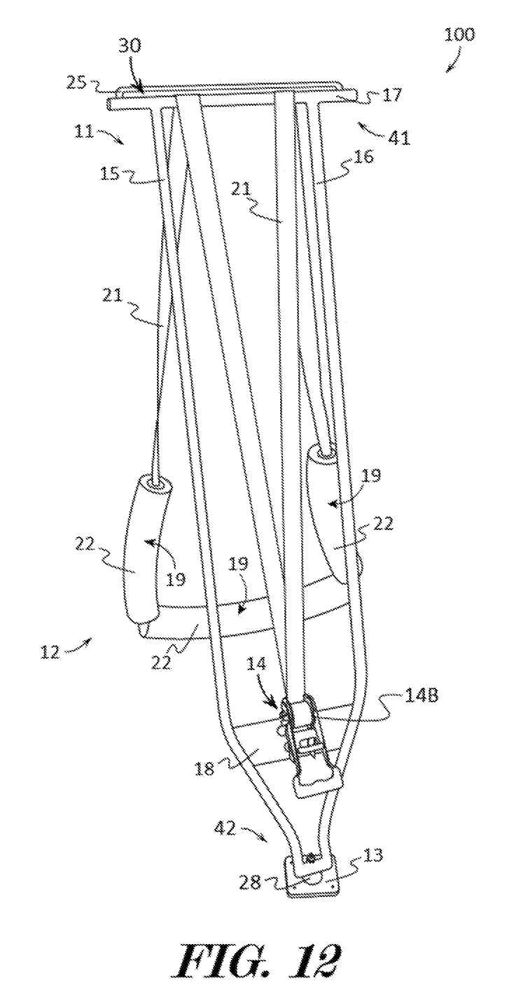

In some embodiments and as shown in FIGS. 1-4, and 8-12, the harness 12 may be operably coupled to a positional motivator 14 so that by operating the positional motivator 14, the distance between a traction surface 19 and the first cross brace 17 and/or a second cross brace 20 may be changed. In further embodiments, the harness loop 21 of the harness 12 may be operably coupled to a positional motivator 14 as shown in FIGS. 10 and 11. In further embodiments the ends of harness 12 may directly connect to the positional motivator(s) 14 as shown in FIG. 12. In other embodiments, device 100 may comprise an extension 24 which may couple the harness loop 21 of the harness 12 to a positional motivator 14 so that the harness 12 may be operably coupled to a positional motivator 14 via the extension as shown in FIGS. 1-4, 8, and 9. In still other embodiments, a harness 12 may be operably coupled to a positional motivator 14 with any number or types of elements so that by operating the positional motivator 14, the distance between a traction surface 19 and the first cross brace 17 and/or a second cross brace 20 may be changed. In alternative embodiments and as shown in FIGS. 1, 2, 10, and 11, the harness 12 may be operably coupled to a positional motivator 14, and the positional motivator 14 may be coupled to the support structure 11, base 13, and/or other element of the device 100 via an extension 24. In yet further embodiments, the harness 12 may be operably coupled to a positional motivator 14 via an extension 24 which is coupled to the harness 12 and to the support structure 11, base 13, and/or other element of the device 100 as shown in FIGS. 1 and 2. In this example, the positional motivator 14 may comprise a hand operated ratchet 14B or cam buckle 14A and the ratchet type positional motivator 14 may tighten and loosen the extension 24 thereby decreasing and increasing the distance between the portions of the harness 12, such as a traction surface 19, and the base 13.

In some embodiments, the device 100 may comprise one or more cushions 22 which may be positioned around or coupled to one or more elements, such as braces 15, 16, 17, 18, a harness 12, and harness loop 21. In preferred embodiments, a harness 12 may comprise a cushion 22 which may be coupled to a harness loop 21 and extend over or surround portions of a harness loop 21 to form all or portions of a traction surface 19. A cushion 22 may be configured to absorb impacts or provide a resilient cushioning layer between an element of the device 100 and a user 200. In further embodiments, the device 100 may comprise one or more traction surfaces 19 which may be formed by one or more cushions 22 of a harness 12.

In some embodiments, a cushion 22 may be made from or comprise a resilient material such as silicone foams, rubber foams, silicone rubber, urethane foams including plastic foams, neoprene foam, latex foam rubber, polyurethane foam rubber, or elastomer materials such as elastic plastics, elastic silicone, elastic rubbers, or any other suitable elastomer or resilient material including combinations of materials. Optionally, a cushion 22 may be covered or otherwise include a material, which is preferably impervious to water, such as rubber or flexible plastic, which may be used to further provide comfort to a user 200 and to protect the cushion 22 material from sweat, cleaning agents, and other contaminants. In some embodiments, the device may comprise two or more cushions 22, while in other embodiments, the device 100 may comprise a cushion 22 which may be elongated and coupled to the harness loop 21 and configured to wrap around the waist of the user 200.

The device 100 may comprise one or more positional motivators which 14 may be configured to control the distance between the base 13 and a traction surface 19 of the harness 12. Generally, a positional motivator may comprise any apparatus or device which may be configured to control, such as by changing and maintaining, the distance between two elements, such as between the base 13 and portions of the harness 12.

In some embodiments and as shown in FIGS. 1-4, 8, and 9-12, the device 100 may comprise a positional motivator 14 which may be configured to govern the distance that the traction surface 19 may be positioned from a first cross brace 17 (FIGS. 3, 4, 8, 9 and 12) and/or a second cross brace 20 (FIGS. 1, 2, 10, 11) of the support structure 11. In further embodiments, the device 100 may comprise a support structure 11 having a first cross brace 17. A harness 12 having a traction surface 19 may be movably coupled to the first cross brace 17 and/or second cross brace 20. A positional motivator 14 may couple the harness 12 to the support structure, optionally via an extension 24. The positional motivator 14 may be configured to control the distance between the traction surface 19 and the first cross brace 17 and/or second cross brace 20. For example, a positional motivator 14 may comprise a ratcheting buckle 14B which may be configured to tighten and loosen an extension 24 coupled to the to the harness 12 as shown in FIGS. 3, 4, 8, and 9. By decreasing the amount of extension 24 wound in the ratcheting buckle 14B, the distance between the traction surface 19 and the first cross brace 17 may be increased. Conversely, by increasing the amount of extension 24 wound in ratcheting buckle 14B the distance between the traction surface 19 and the first cross brace 17 may be decreased. As another example, a positional motivator 14 may comprise a cam buckle 14A (as shown in FIGS. 1, 2, 10, and 11) configured coupled with harness 12 and extension 24 coupled with anchor fastener 33 (FIGS. 1 and 2). Generally, an anchor fastener 33 may comprise a crimp fastener, a threaded fastener, such as a screw or bolt, a rivet, a hook and loop fastener, or any other fastener which may be used to couple a positional motivator 14 to a support structure 11, base, 13, beam 26, or any other element of the device 100. By decreasing the amount of extension 24 fed through the cam buckle 14A type of positional motivator 14, the distance between the traction surface 19 and the cross brace 17, 20 may be increased. Conversely, by increasing the amount of extension 24 fed through the positional motivator 14, the distance between the traction surface 19 and a cross brace 17, 20 may be decreased.

In some embodiments and as shown in FIGS. 5-7, the device 100 may comprise a positional motivator 14 which may be configured to govern the distance that the base 13 may be positioned from the support structure 11. In further embodiments, the device 100 may comprise a support structure 11 having a first cross brace 17. A harness 12 having a traction surface 19 may be coupled to the first cross brace 17. A base 13 may be movably coupled to the support structure 11 via a positional motivator 14, and the positional motivator 14 may be configured to control the distance between the base 13 and the first cross brace 17. By controlling the distance between the base 13 and the first cross brace 17, the positional motivator 14 may also control the distance between the base 13 and the traction surface 19. As an example, a positional motivator 14 may comprise a ratcheting jack 14C which may be configured to motivate a beam 26, to which the base may be coupled to, towards and away from the support structure 11. A ratcheting jack 14C may comprise a hand operated ratcheting jack or farm jack having a beam 26, to which the base 13 may be coupled, with a series of equally spaced holes along its length, and a hand operated mechanism which can be moved from one end of the beam 26 to the other through the use of a pair of climbing pins. The ratcheting jack 14C type positional motivator 14 may retract and extend the beam 26 thereby decreasing and increasing the distance between the base 13 and the support structure 11 resulting in portions of the harness 12, such as a traction surface 19, being moved closer and farther from the base 13. By decreasing the distance that the base 13 is positioned away from the support structure 11, the distance between the traction surface 19 and the base 13 may be decreased. Conversely, by increasing the distance that the base 13 is positioned away from the support structure 11, the distance between the traction surface 19 and the base 13 may be increased.

While a positional motivator 14 has been illustrated as including or comprising a cam buckle 14A, ratcheting buckle 14B, and ratcheting jack 14C, a positional motivator 14 is not limited to these examples. In alternative embodiments, a positional motivator 14 may comprise a friction jack, hydraulic jack or pump, a ratcheting gear set or assembly, or any other hand operable apparatus which may be configured to both change and maintain the distance between two elements. In further alternative embodiments, a positional motivator 14 may comprise an actuator which may be operated by a source of energy, typically electric current, hydraulic fluid pressure, or pneumatic pressure, and converts that energy into motion. Examples of actuators may include comb drives, digital micromirror devices, solenoids, electric motors, electroactive polymers, hydraulic cylinders, piezoelectric actuators, pneumatic actuators, servomechanisms, thermal bimorphs, screw jacks, or any other type of hydraulic, pneumatic, electric, mechanical, thermal, and magnetic type of actuator.

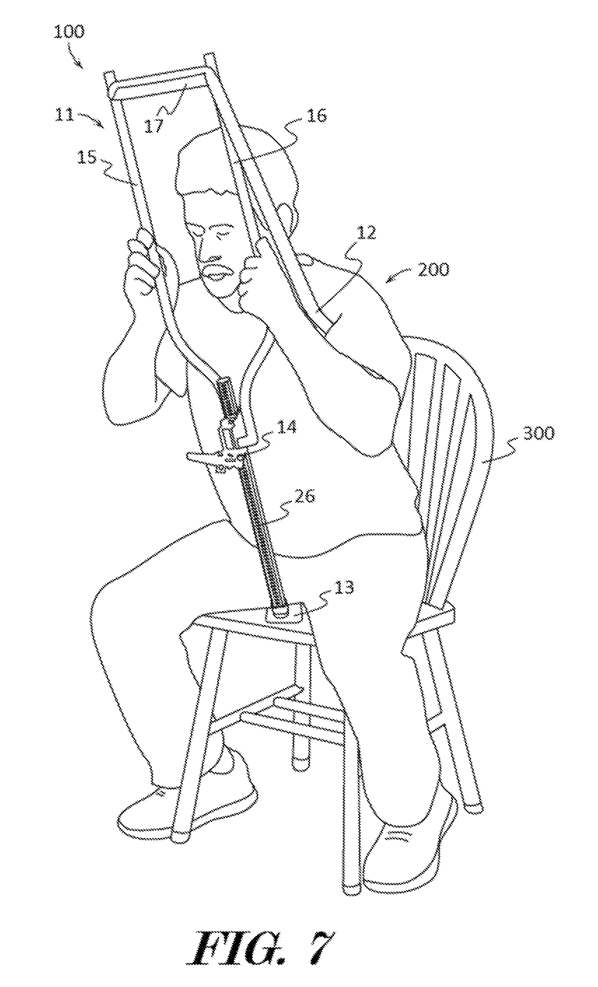

As best illustrated by FIG. 7, the device 100 may be employed by a user 200 to provide decompression to the body. The user 200 may place portions of the harness 12, such as the traction surfaces 19, around their body for example, around the back and below both arms, and also place the base 13 on a surface or object suitable for supporting all or portions of the weight of the user 200. In this example, the base 13 is being supported by a support object 300, although any other object may be used such as a chair, bench, counter, or ground. The user 200 may then manipulate the positional motivator 14 to select a desired distance between the portions of the harness 12, such as the traction surfaces 19, and the base 13. In some embodiments, the positional motivator 14 may be operated so that the positional motivator 14 tensions portions of the harness 12 in contact with the user 200 away from the base 13 so that the positional motivator 14 may provide a user 200 selectable amount of decompression to the body. In other embodiments, once a desired distance between the portions of the harness 12 contacting the body and the base 13 is selected by the user 200 via the positional motivator 14, the user 200 may move or lean their body and the device 100, to vary the desired distance between the portions of the harness 12 and base 13 so that the device 100 may provide a selectable amount of decompression to the body.

While some exemplary shapes and sizes have been provided for elements of the device 100, it should be understood to one of ordinary skill in the art that the support structure 11, harness 12, base 13, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A decompression device, the device comprising:
a support structure having a first cross brace;
a harness movably coupled to the first cross brace, the harness having a traction surface;
a positional motivator coupling the harness to the support structure, wherein the positional motivator is configured to control the distance between the traction surface and the first cross brace; and
a base coupled to the support structure.

2. The device of claim 1, wherein the harness comprises a cushion.

3. The device of claim 2, wherein the traction surface is formed by the cushion.

4. The device of claim 1, wherein the positional motivator is selected from the group consisting essentially of a ratcheting buckle and a cam buckle.

5. The device of claim 1, wherein the support structure comprises a first longitudinal brace, and wherein the first longitudinal brace couples the first cross brace to the base.

6. The device of claim 1, further comprising a first strap aperture, wherein portions of the harness are movably coupled within the first strap aperture to the first cross brace.

7. The device of claim 1, further comprising a second cross brace and a second strap aperture, wherein portions of the harness are movably coupled within the second strap aperture to the second cross brace.

8. The device of claim 1, wherein the harness comprises an adjustable fastener.

9. The device of claim 1, further comprising an extension, and wherein the harness is coupled to the positional motivator via the extension.

10. The device of claim 1, further comprising an extension, and wherein the harness is coupled to the extension via the positional motivator.

11. The device of claim 1, wherein the harness comprises a flexible material.

12. A decompression device, the device comprising:
a support structure having a first cross brace;
a harness coupled to the first cross brace of the support structure, the harness having a traction surface; and
a base movably coupled to the support structure via a positional motivator, wherein the positional motivator is configured to control the distance between the base and the first cross brace.

13. The device of claim 12, wherein the harness comprises a cushion.

14. The device of claim 13, wherein the traction surface is formed by the cushion.

15. The device of claim 12, wherein the positional motivator comprises a ratcheting jack.

16. The device of claim 12, wherein the support structure comprises a first longitudinal brace, and wherein the first longitudinal brace couples the first cross brace to the base.

17. The device of claim 12, further comprising a first strap aperture, wherein portions of the harness are movably coupled within the first strap aperture to the first cross brace.

18. The device of claim 11, wherein the harness comprises an adjustable fastener.

19. The device of claim 11, further comprising an extension, and wherein the harness is coupled to the positional motivator via the extension.

20. The device of claim 11, wherein the harness comprises a flexible material.
